(19) United States
(12) Patent Application Publication
(10) Pub. No.: US 2008/0075902 A1
(43) Pub. Date: Mar. 27, 2008

(54) Injection-Molded Container with Surface Fringe and Method for Manufacturing the Same

(76) Inventors: Jan-Shuan Lin, Tainan County (TW); Yung-Wei Chang, Tainan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/534,138

(22) Filed: Sep. 21, 2006

(51) Int. Cl. B29C 70/78; B32B 27/08

(52) U.S. Cl. 428/35.7; 264/132; 264/268

(57) ABSTRACT

An injection-molded container with surface fringe and a method for manufacturing the same comprises a container and a pattern substrate, wherein the method comprises: firstly, printing and hot pressing the surface of the pattern substrate, to form the pattern of fringe; then, pressing the patterned pattern substrate, so that the pattern substrate has a shape as desired for the container; further, putting the pattern substrate into a mold, so that the pattern substrate has a slightly arc-shaped bottom; and injecting and adhering a material used for the container onto the pattern substrate directly, wherein the arc-shaped bottom of the pattern substrate uniformly disperses the impact of the injected material used for the container to form the shape of the container.

### BACKGROUND OF THE INVENTION

1. Field of the Invention

The present invention relates to a field of an injection-molded container with surface fringe and a method for manufacturing the same and, particularly, to a field wherein a container and the surface fringe thereon is made as a whole so that the surface of the container may have a beautiful and gorgeous appearance produced.

2. Descriptions of the Related Art

The surface fringe known in this disclosure has the desired pattern that is produced on the surface of typical plastic material through incising lines of different densities. Since the surface fringe is formed through cutting, the pattern thereof is not only presented 3-dimensionally (3-D), but also durable and strong. In case that the cutting is combined with coloration, a plentiful variety of graphs may be acquired, which ranges over broad application. Furthermore, that material for surface fringe may be integrated with other transparent material so that the pattern of the surface fringe is presented much more richly under the principle of optics (refraction, scattering, etc.).

The technique for surface fringe as mentioned above has manifested itself in various decorations, e.g., stickers or labels, but it is barely found in application to 3-D modeled containers. The main reason lies in that in typical manufacture of plastic containers, injection molding is adopted frequently, which requires high temperature and high pressure generated to produce 3-D shapes. Such high temperature and high pressure tend to impact the material, e.g., PP (polypropylene), for surface fringe and tend to cause damage to the product thus prevent the containers from manufactured as desired.

Therefore, currently for producing containers with surface fringe, the production is no more than respectively manufacturing the container and a product provided with surface fringe separately, and then cohering and fixing them together. Since the material for surface fringe is an elastic material and it is hard to adhere and fix, similar products are barely available. FIG. 1 shows a product commercially available, which has the surface fringe disposed in a way of insertion like that for a photo frame, wherein the product comprises a container 11, the container 11 having a transparent housing 12 at the exterior thereof, and a pattern substrate 13 provided with surface fringe inserted through the gap 14 between the container 11 and the transparent housing 12. However, the appearance of such a product cannot attain an overall wholeness presentation for neatness and beauty and, thus, lacks marketability.

In view of this, the present inventor(s) has set about the work of development that provides a container having surface fringe on the surface thereof integrated as a whole, and to promote beauty and practicability of the product, by providing novel adjustments to the mold for the container and to the steps of injection molding. The injection-molded container with surface fringe of the present invention has been ultimately achieved desired properties and characteristics through a long-term trial and feasibility studies.

### SUMMARY OF THE INVENTION

It is one objective of the present invention to provide an injection-molded container with surface fringe and a method for manufacturing the same, wherein the container is injection molded onto a substrate provided with surface fringe tightly as a whole, or integrated as a whole, so that the product has desired practicability and visual value.

It is another objective of this invention to provide an injection-molded container with surface fringe and a method for manufacturing the same, which makes the technique for surface fringe certainly applicable to 3-D molded products for broader application of 3-D fringe.

It is a further objective of this invention to provide an injection-molded container with surface fringe and a method for manufacturing the same suitably for various 3-D molded containers such as cups, dishes and bowls.

The present invention provides an injection-molded container with surface fringe and a method for manufacturing the same that fulfill the objectives described above, wherein the injection-molded container with surface fringe comprises structurally an injection-molded container and a pattern substrate provided with fringe on the surface thereof that is formed by printing and hot pressing, and the method comprises: firstly, printing and hot pressing the surface of the pattern substrate, to form the pattern of fringe; then, pressing the patterned pattern substrate, so that the pattern substrate has a shape as desired for the container; further, putting the pattern substrate into a mold, so that the pattern substrate has a slightly arc-shaped bottom; and injecting and adhering a material used for the container onto the pattern substrate directly, wherein the arc-shaped bottom of the pattern substrate may disperse the impact of the injected material used for the container such that the injected material may uniformly form the shape of the container.

### BRIEF DESCRIPTION OF THE DRAWINGS

The drawings disclose an illustrative embodiment of the present invention that serves to exemplify the various advantages and objects hereof, and are as follows:

FIG. 1 is shows the structure of a conventional container with surface fringe;

FIG. 2 shows the appearance of the structure according the present invention;

FIG. 3A is a partially sectional diagram of the structure according the present invention;

FIG. 3B is a partially sectional diagram of a varied structure according the present invention;

FIG. 4 is an exemplifying diagram of the mold set-up according the invention; and

FIG. 5 is the flow chart according the present invention.

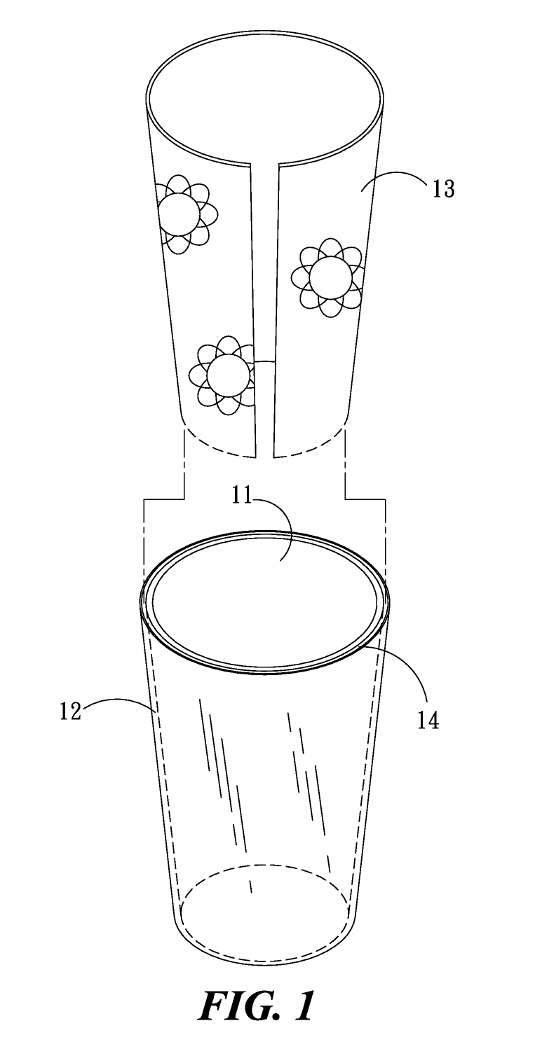

### DESCRIPTION OF THE PREFERRED EMBODIMENT

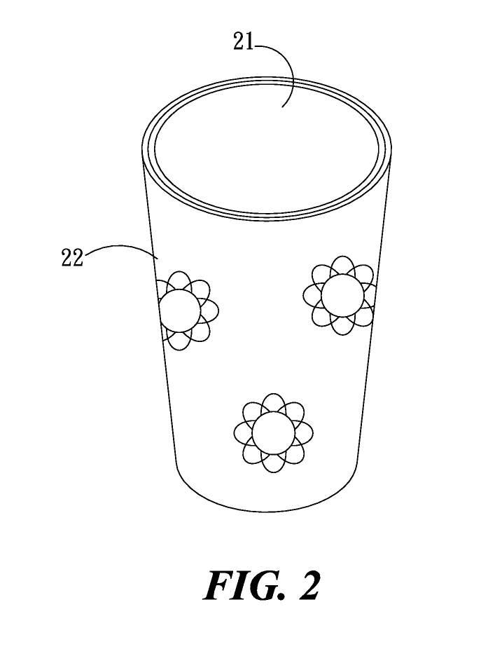

As shown in FIG. 2, the present invention provides an injection-molded container with surface fringe and a method for manufacturing the same, said injection-molded container with surface fringe mainly comprising a container 21, and the container 21 having a surface with a pattern substrate 22 fixed thereon. The pattern substrate 22 is provided with fringe preset on the surface thereof through printing and hot pressing so that different patterns may be formed with hot pressed lines of different distribution densities, depths, widths, colors and the like to meet the user's need. Furthermore, the surface fringe may have the exterior sides thereof with an electroplated metal glossing layer disposed so that the whole structure has a more beautiful appearance. The container 21 is finished through injection molding an appropriate material onto the pattern substrate directly so that the container 21 is integrated with the pattern substrate 22 tightly as a whole.

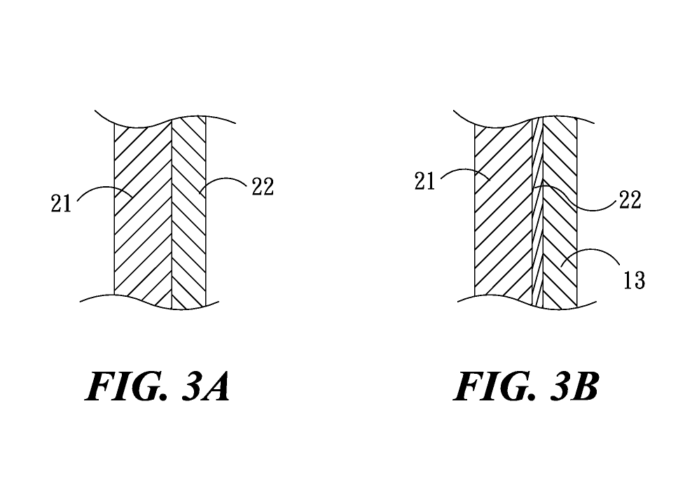

Refer to FIG. 3A. As shown, said container 21 and pattern substrate 22 may be made typically from the same material. In the method for molding, the material used for the container 21 is molten and then injected onto the pattern substrate 22, and the material and the substrate is fused together under high temperature and high pressure and finally cooled to complete the molding. However, as shown in FIG. 3B, direct fusing may fail if different materials are used for the container 21 and the pattern substrate 22. Now, a suitable cohesive 23 may be selected as an interface according to the characteristics of the container 21 and the pattern substrate 22, so that the material used for the container 21, as injected, may be combined with the pattern substrate 22 tightly by the cohesive 23. The cohesive 23 enhances the effect on the cohesion. Besides, the cohesive 23 may block direct impact on the pattern substrate 23 by the high temperature and high pressure of the material for the container 21, to reduce damage to the product. Naturally, a protective layer (not shown) may be disposed between the container 21 and the pattern substrate 22 to minimize damage caused by high temperature and high pressure, but this protective layer must not hinder the cohesion between the container 21 and the pattern substrate 22.

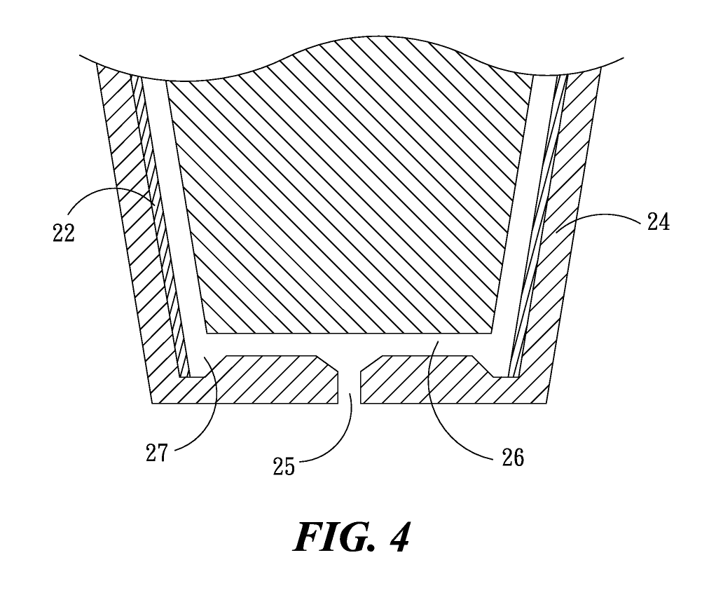

Refer to FIG. 4. As shown, said pattern substrate 22, having surface fringe finished, will be pressed to form a shape as desired for the container 21 and then placed in a mold 24, which has an injection opening 25. The pattern substrate 22 has the bottom thereof having a slightly arc-shaped portion that faces the injection opening 25, so that the arc-shaped portion of the bottom disperses the impact of the injected material used for the container. The injection opening 25 has the sides thereof with runners 26 extended, which are arranged on the surface of the pattern substrate 22 for forming the shape of the container 21, wherein the runners 26 have buffers 27 of larger volume disposed at the turning portions thereof so that the material used for the container 21 may pass the turning portions smoothly and thus fill up the runners 26 to optimize quality and yield of the product.

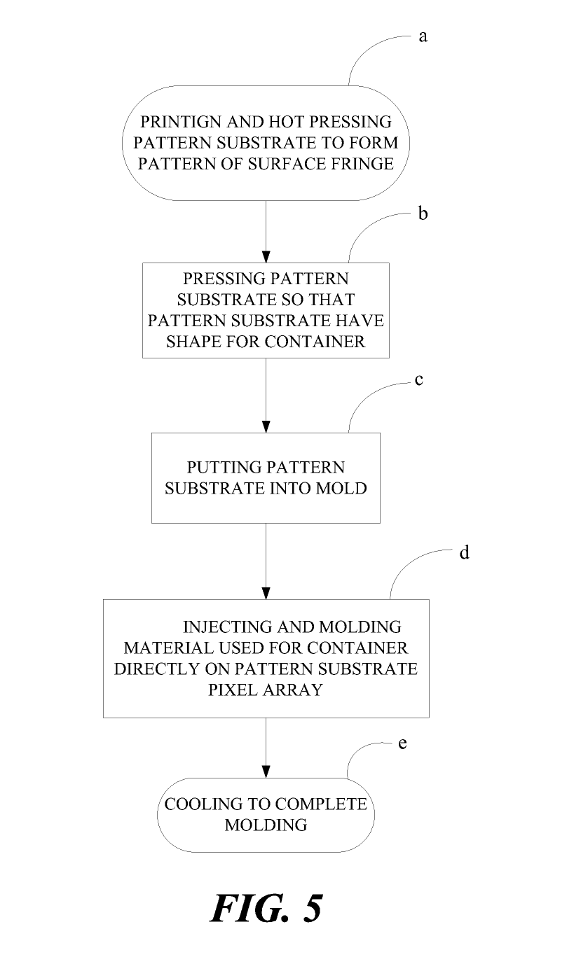

Refer to FIG. 5, which shows the steps of the method of the present invention as follows:

1. printing and hot pressing the surface of a pattern substrate 22, to form the pattern of fringe, wherein the operations of printing and hot pressing may have the sequence thereof being interchangeable, that is, either hot pressing follows printing, or printing follows hot pressing;

2. pressing the patterned pattern substrate with suitable tools, so that the pattern substrate has a shape as desired for a container 21;

3. putting the shaped pattern substrate 22 into a preset mold 24, fixing the pattern substrate 22, and install the injection opening 25 and the runners 26 of the container 21;

4. injecting and fusing a material used for the container 21 onto the surface of the pattern substrate 22 directly under the high temperature and high pressure of the material so as to form the shape of the container 21; and

5. cooling and then releasing the product from the mold, so as to finish the injection-molded container with surface fringe of the present invention.

Said pattern substrate 22 may have a surface thereof with the cohesive 23 disposed, by which the pattern substrate 22 may be fused on the surface of the molded container 21 under the high temperature and high pressure of the material used for the container 21. Moreover, the pattern substrate 22 may have a surface thereof with a protective layer disposed to minimize impact on the pattern substrate 22 by the material used for the container 21.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for manufacturing an injection-molded container with surface fringe, characterized in that the method comprises steps of:
electroplating, printing and hot pressing the surface of a pattern substrate, to form the pattern of fringe;
pressing the patterned pattern substrate, so that the pattern substrate has a shape as desired for the container;
putting the pattern substrate into a mold; and
injecting and adhering a material used for the container onto the pattern substrate directly so as to form the shape of the container.

2. The method for manufacturing an injection-molded container with surface fringe of claim 1, wherein the pattern substrate has a slightly arc-shaped bottom, so that the arc-shaped bottom disperses the impact of the injected material used for the container to promote the quality and yield of the product.

3. The method for manufacturing an injection-molded container with surface fringe of claim 1, wherein the pattern substrate is fused on the surface of the molded container under the high temperature and high pressure of the material used for the container.

4. The method for manufacturing an injection-molded container with surface fringe of claim 1, wherein the pattern substrate has a surface to fuse and cohere with a cohesive disposed, by which the pattern substrate is fused on the surface of the molded container under the high temperature and high pressure of the material used for the container.

5. The method for manufacturing an injection-molded container with surface fringe of claim 1, wherein the pattern substrate has a surface to fuse and cohere with a protective layer disposed for sticking up to the damage of the high temperature and high pressure of the material used for the container to promote the quality and yield of the product.

6. The method for manufacturing an injection-molded container with surface fringe of claim 1, wherein the operations of printing and hot pressing have the sequence thereof being changeable.

7. An injection-molded container with surface fringe, characterized by:
a container;
a pattern substrate, integrated on the surface of the container tightly, and the pattern substrate having surface fringe formed with printed and hot pressed pattern of fringe.

8. The injection-molded container with surface fringe of claim 7, wherein the surface fringe is formed with hot pressed lines of different distribution densities, depths, widths, angles and colors.

9. The injection-molded container with surface fringe of claim 7, wherein the surface fringe has the exterior sides thereof with an electroplated metal glossing layer disposed.

10. The injection-molded container with surface fringe of claim 7, wherein the pattern substrate and the container have the space therebetween with a cohesive disposed.
